(19) United States
(12) Patent Application Publication
(10) Pub. No.: US 2026/0046677 A1
(43) Pub. Date: Feb. 12, 2026

(54) SYSTEMS AND METHODS FOR USER PLANE FUNCTION (UPF) IMPLEMENTATION SERVICE

(71) Applicant: Verizon Patent and Licensing Inc., Basking Ridge, NJ (US)

(72) Inventors: Mourad B. Takla, Hillsborough, NJ (US); Peretz Feder, Englewood, NJ (US); Fernando Oliveira, Bristol, NH (US)

(21) Appl. No.: 18/796,432

(22) Filed: Aug. 7, 2024

(51) Int. Cl. H04W 28/02; G06F 9/48; H04L 47/2425; H04W 28/24

(52) U.S. Cl. CPC H04W 28/0268; G06F 9/4881; H04L 47/2425; H04W 28/0221; H04W 28/24

(57) ABSTRACT

Systems, methods, and computer-readable media described herein include configuring, on one or more network function devices in a core network, a control resource device and a compute resource device; receiving, at one of the one or more network function devices, data from a network session; determining whether the data includes at least one of a first data type or a second data type; and performing, based on the determining, at least one of a first task for the first data type using the control resource device or a second task for the second data type using the compute resource device.

### BACKGROUND

Energy consumption and quality of service (QoS) priority handling server architecture are two considerations in building, deploying, and operating advanced wireless networks, such as Fifth Generation (5G), Sixth Generation (6G), and future networks. In a 5G core network (5GC), a network function (NF), e.g., a user plane function (UPF), processes data traffic between external data networks and multiple radio access networks (RANs) for potentially thousands of concurrent protocol data unit (PDU) sessions-making the UPF a target for performance improvement and in reducing network power consumption and in guaranteeing an agreed service level for specific network functionality requested from different applications.

### BRIEF DESCRIPTION OF THE DRAWINGS

FIG. 1 is a diagram that depicts an exemplary network environment in which systems and methods described herein may be implemented;

FIG. 2 is a diagram illustrating a network portion for a UPF implementation service, according to embodiments described herein;

FIG. 3 is a diagram of example components of a device according to an embodiment described herein;

FIG. 4 is a block diagram showing example logical components of UPF architecture functions for a UPF implementation service;

FIG. 5 is a table illustrating segregated UPF-related tasks, according to an embodiment;

FIG. 6 is a diagram illustrating an exemplary multi-QoS process of a UPF implementation service; and

FIG. 7 is a flow diagram illustrating another exemplary process for providing the UPF implementation service, according to embodiments described herein.

### DETAILED DESCRIPTION

The following detailed description refers to the accompanying drawings. The same reference numbers in different drawings may identify the same or similar elements. Also, the following detailed description does not limit the invention.

Typical UPF implementations use general purpose processors to perform all aspects of UPF functionality. For example, conventional UPF implementations rely on the QoS architecture provided by a data plane development kit (DPDK) framework. Neither network energy efficiency nor QoS priority scheduling of data network traffic flow is optimized by using such processors to perform both routine (e.g., control plane) tasks and compute-intensive (e.g., user plane) tasks performed by the UPF. Thus, the technical challenges that current approaches to UPF implementations present include the limitation on the potential proliferation of distinct guaranteed bit rate (GBR) flows in which a substantial increase in QoS traffic class queues (i.e., more than 12, for example) would be necessary.

Systems and methods described herein segregate UPF operations based on control and computation operations. The systems and methods, herein referred to generally as a UPF implementation service, offload user plane traffic to a data processor unit (DPU) while keeping the control plane traffic managed by a non-dedicated compute engine (e.g., a central processor unit (CPU)). For example, a DPU may be implemented on an additional and/or separate hardware card that is added to a server. According to an implementation, the DPU may include a compute cluster (e.g., multiple general purpose compute engines, a field programmable gate array (FPGA), and/or a combination of processing elements) and an ethernet interface (e.g., a network interface card (NIC)).

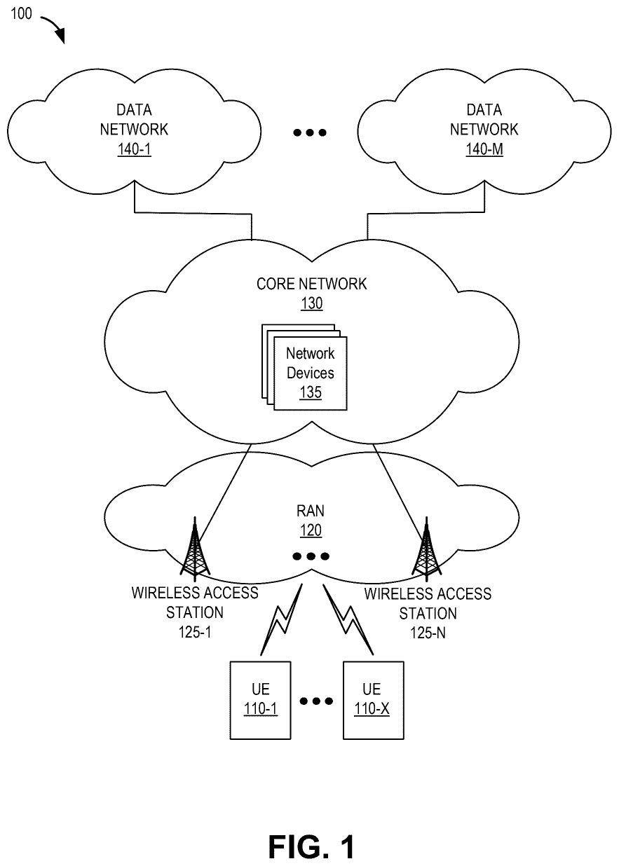

FIG. 1 is a diagram of an example environment 100 in which systems and/or methods of a UPF implementation service, described herein, may be implemented. As shown in FIG. 1, environment 100 may include UE devices 110-1 to 110-X (referred to herein collectively as “UE devices 110” and individually as “UE device 110”), a RAN 120, a core network 130, and data networks 140-1 to 140-M (referred to herein collectively or generically as “data network 140”). RAN 120, core network 130, and data network 140 may be collectively referred to as a transport network.

UE device 110 may include any device with long-range (e.g., cellular or mobile wireless network) wireless communication functionality. For example, UE device 110 may include a handheld wireless communication device (e.g., a mobile phone, a smart phone, a tablet device, etc.); an Internet of Things (IoT) device; a wearable computer device (e.g., a head-mounted display computer device, a head-mounted camera device, a wristwatch computer device, etc.); a telematics system in a vehicle; a laptop computer, a tablet computer, or another type of portable computer; a desktop computer; a customer premises equipment (CPE) device, such as a set-top box or a digital media player, a WI-FI access point, a fixed wireless access (FWA) device, an automated guided vehicle (AGV), a smart television, etc.; a portable gaming system; a global positioning system (GPS) device; a home appliance device; a home monitoring device; and/or any other type of computer device with wireless communication capabilities. UE device 110 may include capabilities for voice communication, mobile broadband services (e.g., video streaming, real-time gaming, premium Internet access etc.), best effort data traffic delivery, and/or other types of capabilities. In some implementations, UE device 110 may communicate using machine-to-machine (M2M) communication, such as machine-type communication (MTC), and/or another type of M2M communication. In still other implementations, UE device 110 may include a Redcap (Reduced capability) device that is used for applications such as industrial wireless sensors. In some implementations, multiple UE devices 110 may be associated in UE device groups, such a group of IoT devices that may be associated via a UE group identifier.

RAN 120 may enable UE devices 110 to wirelessly connect to core network 130 for mobile telephone service, Short Message Service (SMS), Multimedia Message Service (MMS), Internet access, cloud computing, and/or other types of data services. RAN 120 may include wireless access stations 125-1 to 125-N (referred to herein collectively or generically as “wireless access station 125”). Each wireless access station 125 may service a set of UE devices 110. For example, wireless access station 125-1 may service some UE devices 110 when the UE devices 110 are located within the geographic area serviced by wireless access station 125-1, while other UE devices 110 may be serviced by another wireless access station 125 when the other UE devices 110 are located within the geographic area serviced by the other wireless access station 125.

Wireless access station 125 may include a 5G base station (e.g., a next generation Node B (gNB)) that includes one or more radio frequency (RF) transceivers configured to send and receive 5G New Radio (NR) wireless signals. According to an implementation, wireless access station 125 may include a gNB or its equivalent with multiple distributed components, such as a central unit (CU), a distributed unit (DU), a remote unit (RU) or a remote radio unit (RRU), or another type of component to support distributed arrangements. In some implementations, wireless access station 125 may also include a Fourth Generation (4G) base station (e.g., an eNB and/or a 6G base station). Furthermore, in some implementations, wireless access station 125 may include a Multi-Access Edge Computing (MEC) system that performs cloud computing and/or provides network processing services for UE devices 110.

Core network 130 may manage communication sessions for UE devices 110. Core network 130 may provide mobility management, session management, authentication, and packet transport, to support wireless communication services for UE devices 110. Core network 130 may further provide access to data networks 140. Core network 130 may support known wireless standards which may include, for example, Third Generation Partnership Project (3GPP) 5G (non-standalone (NSA) and standalone (SA)), Long-Term Evolution (LTE), LTE Advanced, Global System for Mobile Communications (GSM), etc. For example, core network 130 may establish an Internet Protocol (IP) connection between UE device 110 and a particular data network 140.

Core network 130 may include various types of network devices 135, which may implement different network functions described further herein. Network device 135 may include a physical function node or a virtual network function (VNF). Thus, the components of core network 130 may be implemented as dedicated hardware components and/or as VNFs implemented on top of a common shared physical infrastructure (referred to herein collectively as network device 135). Network device 135 may include, for example, a 5G network function; a 4G network node; a transport network device, such as, for example, a switch, router, firewall, gateway, an optical switching device (e.g., a reconfigurable optical add-drop multiplexer, etc.), and/or another type of network element. Network devices 135 may include devices that implement network functions such as, among others, an Access and Mobility Management Function (AMF); a Session Management Function (SMF); a UPF; a Network Exposure Function (NEF) to expose services to third-party servers; an Application Function (AF) to provide services associated with a particular application; a Policy Control Function (PCF); a Unified Data Management (UDM); a Network Data Analytics Function (NWDAF); an Energy Management Function (EMF); a Network Slice Selection Function (NSSF), and a charging function (CHF). In other implementations, network devices 135 may also include functions for a 4G LTE core network (e.g., an evolved packet core (EPC) network).

Data networks 140 may each include a packet data network. A particular data network 140 may include, and/or be connected to and enable communication with, a local area network (LAN), a wide area network (WAN), a metropolitan area network (MAN), an optical network, a cable television network, a satellite network, a wireless network, an intranet, or a combination of networks. Some or all of a particular data network 140 may be managed by a communication services provider that also manages core network 130, RAN 120, and/or particular UE devices 110. For example, in some implementations, a particular data network 140 may include an IP Multimedia Sub-system (IMS) network (not shown in FIG. 1). An IMS network may include a network for delivering IP multimedia services and may provide media flows between two different UE devices 110, and/or between a particular UE device 110 and external IP networks or external circuit-switched networks (not shown in FIG. 1).

Network slicing may be implemented through RAN 120, core network 130, and data network 140 (e.g., a transport network). Network slicing is a technology available in advanced wireless networks, and is based on the creation of multiple virtual networks on a common physical infrastructure. As described further herein, a future scheduler requirement combining priority handling of IP flows plus slice-differentiated priority handling may be implemented in a DPU. Alternatively, executing such a combined scheduler (i.e., IP flow priority+slice priority) in the server may not yield the same performance and may require significant additional server resources.

Although FIG. 1 shows exemplary components of environment 100, in other implementations, environment 100 may include fewer components, different components, differently arranged components, or additional components than depicted in FIG. 1. Additionally, or alternatively, one or more components of environment 100 may perform functions described as being performed by one or more other components of environment 100.

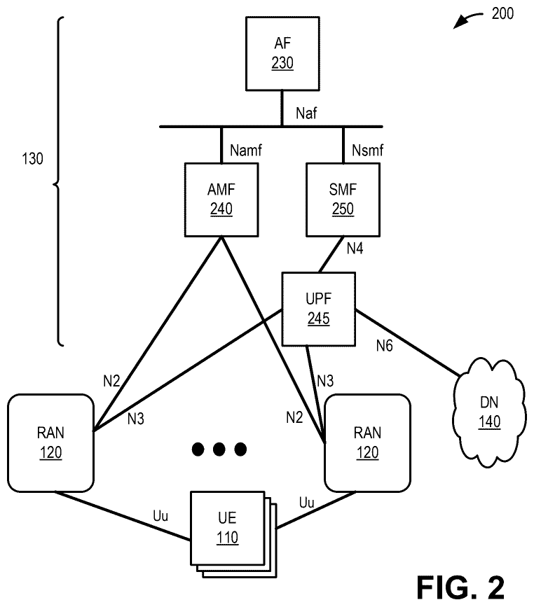

FIG. 2 is a diagram illustrating a network portion 200 that includes exemplary components of environment 100 in the context of a UPF implementation service deployed in core network 130, according to an embodiment described herein. As shown in FIG. 2, network portion 200 may include one or more UE devices 110, RAN 120, data network (DN) 140, and various components of core network 130 described below. While FIG. 2 depicts a single instance of the NFs in network portion 200 for illustration purposes, in practice, there may be multiple instances of one or more NFs.

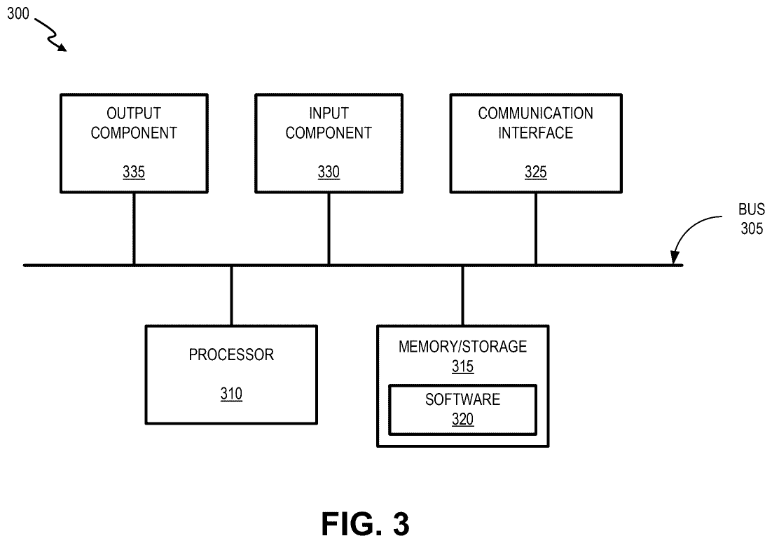

The components depicted in FIG. 2 may be implemented as dedicated hardware components and/or as virtualized functions implemented on top of a common shared physical infrastructure using software defined networking (SDN). For example, an SDN controller may implement one or more of the components of FIG. 2 using an adapter implementing a virtual machine, a containerized network function (CNF) container, an event driven serverless architecture interface, and/or another type of SDN architecture. The common shared physical infrastructure may be implemented using one or more devices 300 described below with reference to FIG. 3 in a cloud computing center associated with core network 130.

Components of core network 130 may correspond to and/or be implemented via one or more network devices 135. As shown in FIG. 2, components of core network 130 may include an AMF 240, a UPF 245, and an SMF 250. An Application Function (AF) 230 may also be included as part of core network 130 or a separate network (e.g., an orchestration or provisioning network, not shown). UE device 110, RAN 120, and data network 140 may include features described above in connection with FIG. 1.

AF 230 may provide services associated with a particular application, such as, for example, interacting with a policy framework for policy control, influencing traffic routing, and/or other types of services. AF 230 may access services provided in core network 130 or data network 140. In instances where AF 230 is outside of core network 130 and/or is not a trusted device, a network exposure function (NEF) (not shown) may expose to AF 230 the mobile network's capability to support network services. AF 230 may be accessible via an Naf interface.

AMF 240 may perform registration management, connection management, reachability management, mobility management, lawful intercepts, Short Message Service (SMS) transport, session management message transport between UE device 110 and SMF 250, access authentication and authorization, location services management, functionality to support non-3GPP access networks, and/or other types of management processes. AMF 240 may be accessible to RAN 120 via an N2 interface and to core network devices via an Namf interface.

UPF 245 may maintain an anchor point for intra/inter-radio access technology (RAT) mobility, maintain an external PDU point of interconnect to a particular data network 140, perform packet routing and forwarding, perform the user plane part of policy rule enforcement, perform packet inspection, perform lawful intercept, perform traffic usage reporting, perform QoS handling in the user plane, perform uplink traffic verification, perform transport level packet marking, perform downlink packet buffering, forward an “end marker” to a RAN 120 node (e.g., access station 125), and/or perform other types of user plane processes. UPF 245 may be accessible to RAN 120 via an N3 interface and to SMF 250 via an N4 interface, for example.

SMF 250 may perform session establishment, session modification, and/or session release, perform IP address allocation and management, perform Dynamic Host Configuration Protocol (DHCP) functions, perform selection and control of UPF 245, configure traffic steering at UPF 245 to guide the traffic to the correct destinations, terminate interfaces toward a PCF (not shown), perform lawful intercepts, charge data collection, support charging interfaces, control and coordinate charging data collection, perform downlink data notification, manage roaming functionality, and/or perform other types of control plane processes for managing user plane data. SMF 250 may be accessible to core devices via an Nsmf interface.

Although FIG. 2 shows certain components of network portion 200, in other implementations, network portion 200 may include fewer components, different components, differently arranged components, or additional components than depicted in FIG. 2. For example, although not illustrated in FIG. 2, core network 130 may include other network functions, such as a NEF, a UDM function, a PCF, an NWDAF, an event charging function (ECF), a Charging Enablement Function (CEF), a Network Repository Function (NRF), an NSSF, etc. Additionally, or alternatively, one or more components of network portion 200 may perform functions described as being performed by one or more other components of network portion 200. Furthermore, while particular interfaces (e.g., N2, N3, N4, N6, Namf, Nsmf, etc.) are illustrated with respect to particular function nodes in FIG. 2, some network functions may include other interfaces, such as a reference point architecture that includes point-to-point interfaces between particular function nodes.

FIG. 3 illustrates example components of a device 300 according to an implementation described herein. UE device 110, wireless access station 125, network device 135, AF 230, AMF 240, UPF 245, SMF 250, and other devices in environment 100 may each include one or more devices 300 and/or be implemented via one or more devices 300.

As illustrated in FIG. 3, device 300 includes a bus 305, one or more processors 310, memory/storage 315 that stores software 320, a communication interface 325, an input component 330, and an output component 335. According to other embodiments, device 300 may include fewer components, additional components, different components, and/or a different arrangement of components than those illustrated in FIG. 3 and described herein.

Bus 305 includes a path that permits communication among the components of device 300. For example, bus 305 may include a system bus, an address bus, a data bus, and/or a control bus. Bus 305 may also include bus drivers, bus arbiters, bus interfaces, and/or clocks.

Processor 310 includes one or multiple processors, microprocessors, data processors, co-processors, application specific integrated circuits (ASICs), controllers, programmable logic devices, chipsets, field-programmable gate arrays (FPGAs), application specific instruction-set processors (ASIPs), system-on-chips (SoCs), central processing units (CPUs) (e.g., one or multiple cores), microcontrollers, and/or some other type of component that interprets and/or executes instructions and/or data. Processor 310 may be implemented as hardware (e.g., a microprocessor, etc.), a combination of hardware and software (e.g., a SoC, an ASIC, etc.), may include one or multiple memories (e.g., cache, etc.), etc. Processor 310 may be a dedicated component or a non-dedicated component (e.g., a shared resource).

Processor 310 may control the overall operation or a portion of operation(s) performed by device 300. Processor 310 may perform one or multiple operations based on an operating system and/or various applications or computer programs (e.g., software 320). Processor 310 may access instructions from memory/storage 315, from other components of device 300, and/or from a source external to device 300 (e.g., a network, another device, etc.). Processor 310 may perform an operation and/or a process based on various techniques including, for example, multithreading, parallel processing, pipelining, interleaving, etc.

Memory/storage 315 includes one or multiple memories and/or one or multiple other types of storage mediums. For example, memory/storage 315 may include one or multiple types of memories, such as, random access memory (RAM), dynamic random-access memory (DRAM), cache, read only memory (ROM), a programmable read only memory (PROM), a static random-access memory (SRAM), a single in-line memory module (SIMM), a dual in-line memory module (DIMM), a flash memory (e.g., a NAND flash, a NOR flash, etc.), and/or some other type of memory. Memory/storage 315 may include a hard disk (e.g., a magnetic disk, an optical disk, a magneto-optic disk, a solid-state disk, etc.), a Micro-Electromechanical System (MEMS)-based storage medium, and/or a nanotechnology-based storage medium. Memory/storage 315 may store data, software, and/or instructions related to the operation of device 300.

Software 320 includes an application or a program that provides a function and/or a process. Software 320 may include an operating system. Software 320 is also intended to include firmware, middleware, microcode, hardware description language (HDL), and/or other forms of instruction. According to one example, aspects of the UPF implementation service may be implemented as software 320, such as, for example, implementation of host 405 as a UPF element.

Communication interface 325 permits device 300 to communicate with other devices, networks, systems, devices, and/or the like. Communication interface 325 includes one or multiple wireless interfaces and/or wired interfaces. For example, communication interface 325 may include one or multiple transmitters and receivers, or transceivers (e.g., radio frequency transceivers). Communication interface 325 may include one or more antennas. For example, communication interface 325 may include an array of antennas. Communication interface 325 may operate according to a protocol stack and a communication standard. Communication interface 325 may include various processing logic or circuitry (e.g., multiplexing/de-multiplexing, filtering, amplifying, converting, error correction, etc.).

Input component 330 (also referred to as “input 330”) permits an input into device 300. For example, input 330 may include a keyboard, a mouse, a display, a button, a switch, an input port for stored data, speech recognition logic, a biometric mechanism, a microphone, a visual and/or audio capturing device (e.g., a camera, etc.), and/or some other type of visual, auditory, tactile, etc., input component. Output component 335 (also referred to as “output 335) permits an output from device 300. For example, output 335 may include a speaker, a display, a light, an output port, and/or some other type of visual, auditory, tactile, etc., output component. According to some embodiments, input 330 and/or output 335 may be a device that is attachable to and removable from device 300.

Device 300 may perform a process and/or a function, as described herein, in response to processor 310 executing software 320 stored by memory/storage 315. By way of example, instructions may be read into memory/storage 315 from another memory/storage 315 (not shown) or read from another device (not shown) via communication interface 325. The instructions stored by memory/storage 315 cause processor 310 to perform a process described herein. Alternatively, for example, according to other implementations, device 300 performs a process described herein based on the execution of hardware (processor 310, etc.).

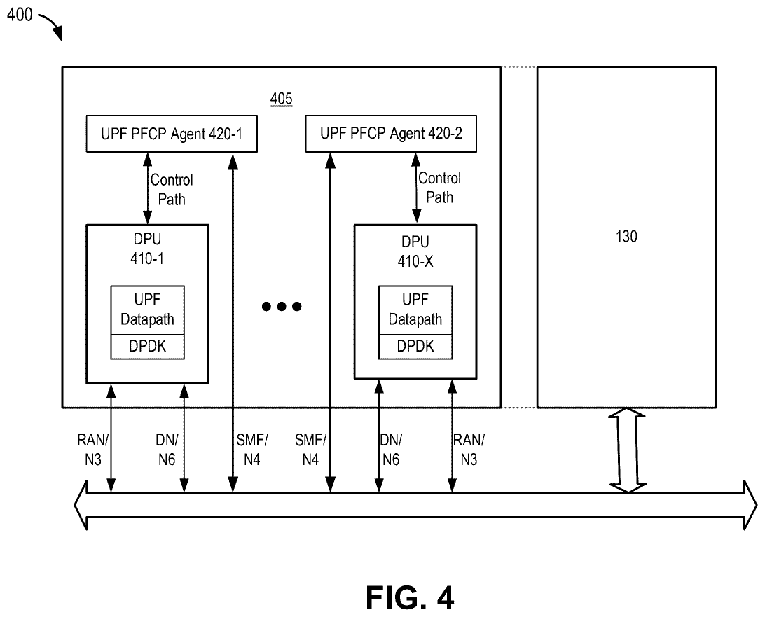

FIG. 4 is a block diagram illustrating examples of logical components of a DPU implementation environment 400 to support a UPF implementation service. According to various exemplary embodiments, DPU implementation environment 400 may include a host device 405 implemented as a network device. For example, the network device may be a computer and/or server device that provides an application service or a microservice. According to other examples, host device 405 may relate to various types of network devices that may reside in a RAN, a core network, a transport network, other types of networks, as described herein. For example, the network device may include or be implemented via a core device, such as a UPF and/or other network function or application function. DPU implementation environment 400 may include various planes of communication including, for example, a control plane, a user plane, a service plane, and/or a network management plane. DPU implementation environment 400 may include other types of planes of communication.

As shown in FIG. 4, DPU implementation environment 400 may include DPU devices 410-1 to 410-X (referred to herein collectively as “DPU devices 410” and individually as “DPU device 410”), and UPF packet forwarding control protocol (PFCP) agents 420-1 to 420-X (referred to herein collectively as “UPF PFCP agents 420” and individually as “UPF PFCP agent 420”). In some embodiments, host device 405 may include, for example, up to eight or more DPU devices 410 and/or up to eight or more UPF PFCP agents 420.

According to one embodiment, DPU devices 410 may include a DPU-based NIC, an Intelligent NIC (iNIC), a programmable NIC, a programmable network adapter, or other type of hardware (e.g., an ASIC, an SoC, an FPGA, or other suitable form factor), which is referred to herein simply as a “SmartNIC.” According to an exemplary embodiment, the SmartNIC is hardware (or a device) that is separate and apart from the hardware resources upon which a virtualized device, such as a network function or other node, runs or operates. In this way, for example, the SmartNIC may offload one or more tasks that may otherwise be performed by resources of the virtualized device. For example, DPU device 410 may perform tasks related to a UPF datapath and/or a data plane development kit (DPDK) framework, as shown, as well as other tasks described herein. Control paths may be established between corresponding UPF PFCP agents 420 and DPU devices 410.

Although FIG. 4 shows examples of logical components of DPU implementation environment 400, in other embodiments, DPU implementation environment 400 may include fewer components, different components, or additional components than depicted in FIG. 4. In addition, functions described as being performed by one of the logical components in FIG. 4 may alternatively be performed by another one or more of the components of DPU implementation environment 400.

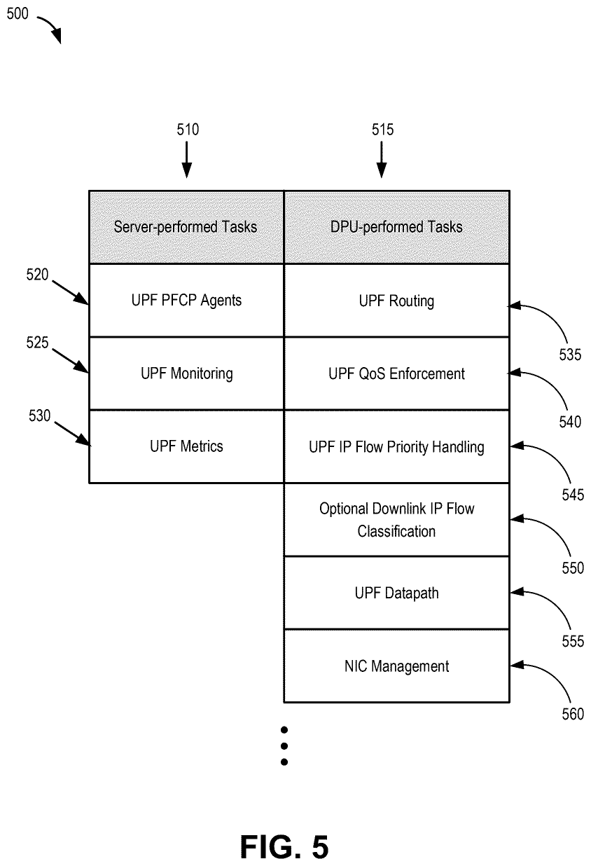

FIG. 5 is a diagram illustrating a designation of UPF-related tasks of those for which performance is segregated into server device (e.g., the main CPU) tasks and those for which performance is offloaded to a dedicated DPU. A table 500 may include a server-performed tasks field 510, and a DPU-performed task field 515, and a variety of entries that associate certain UPF-related tasks with certain UPF devices. According to one embodiment, segregation of the UPF-related tasks is made according to a relative compute-intensiveness associated with each task. In some embodiments, distinct compute resources and control resources are implemented in a UPF instance.

As shown in FIG. 5, exemplary server-performed tasks 510 may include an entry 520 identified as “UPF PFCP Agents” to handle, for example, N4 communication with SMF 250, an entry 525 identified as “UPF monitoring” to perform, for example, monitoring of UPF 245, and an entry 530 identified as “UPF metrics” to collect, for example, UPF Key Performance Indicators (KPIs). According to an implementation described herein, exemplary DPU-performed tasks 515 may include an entry 535 identified as “UPF routing” to handle, for example, the layer 3 routing of uplink and downlink IP flows and/or define the destination of a packet, an entry 540 identified as “UPF QoS enforcement” to enforce, for example, the assigned bit rates of the various QoS flows, an entry 545 identified as “UPF IP flow priority handling” to provide, for example, priority handling for the QoS flows and determine the order in which the flows should be transmitted, an entry 550 identified as “optional downlink IP flow classification” to assign, for example, the QoS identifiers of flows arriving from various applications, an entry 555 identified as “UPF Datapath” to handle, for example, the n3 interface with RAN 120 and the n6 interface with Data Networks 140 and/or an entry 560 identified as “NIC management” to handle, for example, the management, control and/or configuration of the NIC interface.

Although FIG. 5 shows an exemplary segregation of UPF-related tasks to be performed by either the CPU or the DPU, in other embodiments, the UPF-related tasks may include fewer tasks, different tasks, or additional tasks than depicted in FIG. 5. In addition, tasks described as being performed by one of the CPU or the DPU may alternatively be performed by another one or more of the CPU or the DPU.

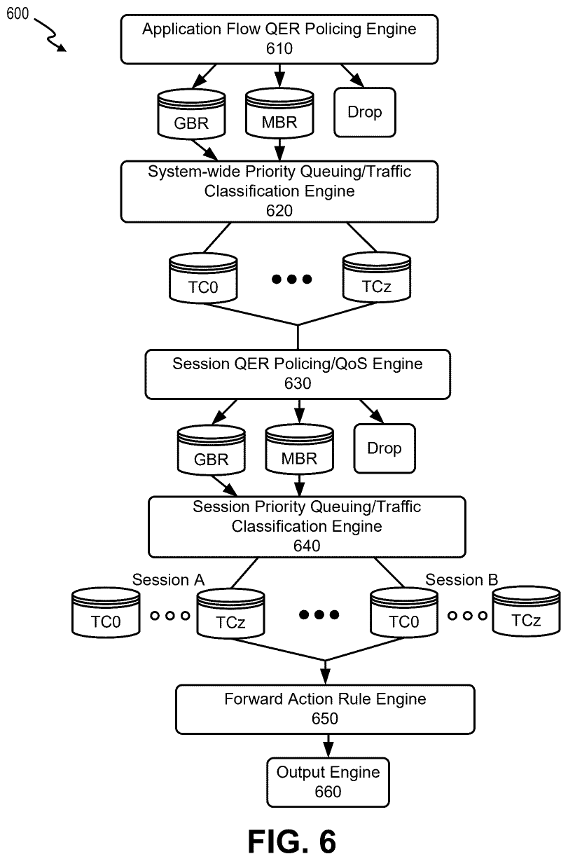

FIG. 6 is a diagram illustrating an exemplary process 600 for providing a UPF implementation service, according to embodiments described herein. In one embodiment, process 600 may be executed on host device 405 (e.g., executing on DPU 410). In another embodiment, process 600 may be implemented by one or more network devices 135.

Process 600 may include a DPU multi-QoS implementation that may follow some of the QoS requirements in various technical standards (e.g., 3GPP standards), to apply priority handling of QoS flows of the same UE 110 and also apply priority handling of QoS flows from different UEs 110 across the system. In the multi-QoS implementation, for each incoming packet during a bit rate interval, an application flow QoS enforcement rule (QER) policing engine 610 may identify an applicable application QER table entry to use. If the amount of data in a packet is less than or equal to the guaranteed bit rate (GBR) included in the application QER entry, application flow QER policing engine 610 may forward the packet to a GBR queue. If the amount of data in a packet is greater than the GBR but less than or equal to the maximum bit rate (MBR) included in the QER entry, application flow QER policing engine 610 may forward the packet to an MBR queue. If the amount of the data in a packet exceeds the MBR included in the application QER entry, application flow QER policing engine 610 may discard (i.e., drop) the packet. In an exemplary implementation, the GBR queue is service/drained before the MBR queue is serviced.

Process 600 may further include system-wide priority queueing/traffic classification engine 620 applying priority handling from different UEs. For each incoming packet, system-wide priority queueing/traffic classification engine 620 may identify an applicable 5G QoS identifier (5QI) flow/value identifier/entry (QFI) index associated with the packet. System-wide priority queueing/traffic classification engine 620 may also enqueue the packet in a priority queue (e.g., a traffic classification (TC) queue) associated with the priority value included in the 5QI value entry. In accordance with an exemplary implementation, system-wide priority queuing/traffic classification engine 620 may classify the packets in 16 different classes (e.g., queues TC0 to TC15). However, it should be understood that more or less different numbers of classes/queues (e.g., more or less than 16, such as an unlimited number of classes/queues based on the availability of memory space) may be used in other implementations.

Process 600 may further include a session QER policing/QoS engine 630 to handle QoS flows priority of a particular UE session. For each incoming packet during a bit rate interval, QER policing/QoS engine 630 may identify an applicable session QER table to use. If the amount of data in the packet is less than or equal to the GBR included in the QER entry, session QER policing/QoS engine 630 may forward the packet to a GBR queue. If the amount of data in the packet is greater than the GBR but less than or equal to the MBR included in the session QER entry, session QER policing/QoS engine 630 may queue the packet on a session MBR queue. If the amount of the data in the packet exceeds the MBR included in the session QER entry, session QER policing/QoS engine 630 may discard/drop the packet.

Process 600 may further include using a session priority queueing/traffic classification engine 640. For each incoming packet, session priority queueing/traffic classification engine 640 may identify the session identifier (ID) of the packet. Session priority queueing/traffic classification engine 640 may also identify an applicable 5G QoS identifier (5QI) flow/value identifier/entry (QFI) index associated with the packet. If a priority queue (e.g., SessionID, 5QI priority value) does not exist, session priority queueing/traffic classification engine 640 may create a session priority queue and order entries in the queue using the assigned priority value. Session priority queueing/traffic classification engine 640 may enqueue the packet in the session priority queue associated with the 5QI priority value or the SessionID. In an exemplary implementation, session priority queueing/traffic classification engine 640 may queue the packets in 16 different priority queues. However, it should be understood that other unlimited numbers of different priority queues (e.g., more than 16 or less than 16) may be used in other implementations. In an exemplary implementation, all queues may be services in order of priority (e.g., TC0 services before TC1, TC1 services before TC2, etc.).

Process 600 may further include using a forward action rule (FAR) engine 650. FAR engine 650 may perform a FAR evaluation for output of the packets and output the packets to an output engine 660. For each incoming packet, output engine 660 may identify a port to which the packet is to be sent. If the port is overloaded, then output engine 660 may signal a backpressure operation to one or more of the aforementioned upstream engines. In each case, the packet may be forwarded to the appropriate port.

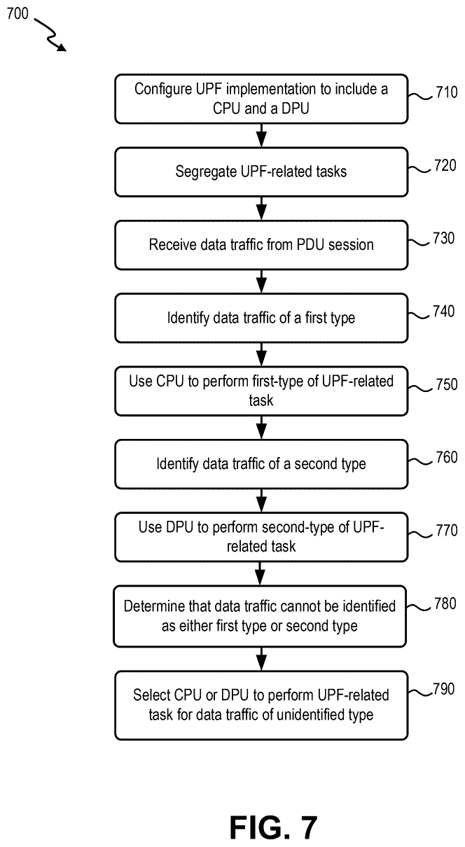

FIG. 7 is a flow diagram illustrating another exemplary process 700 for providing a UPF implementation service, according to embodiments described herein. In one embodiment, process 700 may be executed on host device 405 (e.g., executing on DPU 410). In another embodiment, process 700 may be implemented by one or more network devices 135.

Process 700 may include configuring multiple DPUs 410 (e.g., up to eight or more) on a single server in core network 130 (block 710) to implement UPF 245, and identifying those UPF-related tasks that are to be offloaded from system CPUs to DPUs 410 (block 720). For example, as described in connection with FIG. 5, a determination may be made that UPF 245 is to keep processing of control plane data at the system CPUs, while offloading processing of user plane data to DPUs 410. In other embodiments, segregation of the PDU session data may be based on a relative compute-intensity associated with a type of data and/or UPF-related tasks to be performed. For example, for high compute-intensity PDU session data, UPF-related tasks such as UPF routing, UPF QoS enforcement, UPF IP flow priority handling, optional downlink IP flow classification, UPF datapath, NIC management, and the like, the processing may be performed by DPUs 410, while low compute-intensity PDU session data UPF-related tasks, such as tasks performed by UPF PFCP agents, UPF monitoring, and generating UPF metrics and the like, the processing may be performed by system CPUs.

Process 700 may further include receiving data traffic from a PDU session (block 730) and identifying data traffic of a first type (block 740). For example, A PDU session may be established for UE 110 using AMF 240 and/or SMF 250, and UPF 245 may identify some of the PDU session data traffic to be control plane data. In one embodiment, UPF PFCP agent 420 may perform one or more UPF-related tasks with respect to the identified control plane data (block 750).

Process 700 may also include UPF 240 identifying at least some of the data traffic to be of a second type (block 760). For example, UPF 245 may identify some of the PDU session data traffic to be user plane data. In one embodiment, DPU 410 may perform one or more UPF-related tasks with respect to the identified user plane data (block 770). For example, system CPUs may offload UPF QoS enforcement to DPU 410.

Process 700 may additionally include determining that the PDU session data is associated with neither the first type of data (e.g., control plane data) nor the second type of data (e.g., user plane data) (block 780). For example, the PDU session data may be neither control plane data nor user plane data. For such data such as in-band management data, UPF 245 or another network device may select either system CPUs or DPU 410 to perform a UPF-related task based on a relative compute-intensive parameter for the non-control plane, non-user plane PDU session data (block 790). For example, if the compute-intensity is relatively high, DPU 410 may be selected to process the non-control plane, non-user plane PDU session data.

Systems and methods described herein provide a UPF implementation service that leverages multiple DPUs to increase the performance capacity of a UPF-related device or server and allows scheduling of enhanced user plane priority management which combine IP flow priority and slice priority. For example, a high priority slice may be handled by DPU 410. In one implementation, each DPU can be loaded up to 100% of its capacity independent of the CPU and up to n amount of DPUs per server may be used, for an upscale of up to n×100% as compared to a single DPU. The ability to process the data path user plane in dedicated hardware enables the addition of extra-functionality without sacrificing performance, while reducing power consumption to a target level. For example, using hardware (e.g., a DPU or CPU) optimized for particular tasks and/or types of tasks enables power savings to be realized.

The foregoing description of implementations provides illustration but is not intended to be exhaustive or to limit the invention to the precise form disclosed. Modifications and variations are possible in light of the above teachings or may be acquired from practice of the invention. Also, while series of blocks have been described with regard to the processes illustrated in FIGS. 6 and 7, the order of the blocks may be modified according to other embodiments.

Certain features described above may be implemented as “logic” or a “unit” that performs one or more functions. This logic or unit may include hardware, such as one or more processors, microprocessors, application specific integrated circuits, or FPGAs, software, or a combination of hardware and software.

To the extent the aforementioned embodiments collect, store or employ personal information of individuals, it should be understood that such information shall be collected, stored and used in accordance with all applicable laws concerning protection of personal information. Additionally, the collection, storage and use of such information may be subject to consent of the individual to such activity, for example, through well known “opt-in” or “opt-out” processes as may be appropriate for the situation and type of information. Storage and use of personal information may be in an appropriately secure manner reflective of the type of information, for example, through various encryption and anonymization techniques for particularly sensitive information.

Use of ordinal terms such as “first,” “second,” “third,” etc., in the claims to modify a claim element does not by itself connote any priority, precedence, or order of one claim element over another, the temporal order in which acts of a method are performed, the temporal order in which instructions executed by a device are performed, etc., but are used merely as labels to distinguish one claim element having a certain name from another element having a same name (but for use of the ordinal term) to distinguish the claim elements.

No element, act, or instruction used in the description of the present application should be construed as critical or essential to the invention unless explicitly described as such. Also, as used herein, the article “a” is intended to include one or more items. Further, the phrase “based on” is intended to mean “based, at least in part, on” unless explicitly stated otherwise.

In the preceding specification, various preferred embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method comprising:
configuring, on one or more network function devices in a core network, a control resource device and a compute resource device;
receiving, at one of the one or more network function devices, data from a network session;
determining whether the data includes at least one of a first data type or a second data type; and
performing, based on the determining, at least one of a first task for the first data type using the control resource device or a second task for the second data type using the compute resource device.

2. The method of claim 1, wherein the one or more network function devices comprise a user plane function (UPF) device; and
wherein the first task comprises a first UPF-related task and the second task comprises a second UPF-related task.

3. The method of claim 2, wherein determining whether the data includes at least one of a first data type or a second data type further comprises determining that some of the data is of an unidentified data type, and
wherein the method further comprises selecting the control resource device or the compute resource device to perform a third UPF-related task for the unidentified data type.

4. The method of claim 1, wherein the control resource device comprises a central processing unit (CPU) provisioned on a computer device; and
wherein the compute resource device comprises a data processing unit (DPU) provisioned on the computer device, and wherein the DPU comprises a smart network interface card.

5. The method of claim 4, wherein the compute resource device comprises at least two DPUs provisioned on the computer device, and
wherein the CPU comprises a user plane function (UPF) packet forwarding control protocol (PFCP) agent.

6. The method of claim 1, further comprising:
providing priority handling for data flows having a quality of service (QoS) flow identifier (QFI) index value corresponding to a Fifth Generation QoS identifier (5QI), wherein the providing priority handling comprises:
storing packets having a particular QFI index value in a priority queue.

7. The method of claim 1, further comprising:
determining whether an amount of data in a received packet is less than or equal to the guaranteed bit rate (GBR) identified in a quality of service (QoS) enforcement rule;
forwarding, in response to determining that the amount of data in the received packet is less than or equal to the GBR identified in the QoS enforcement rule, the received packet to a GBR queue;
determining whether an amount of data in the received packet is greater than the GBR but less than or equal to a maximum bit rate (MBR) identified in a QoS enforcement rule; and
forwarding, in response to determining that the amount of data in the received packet is greater than the GBR, but less than or equal to the MBR, the received packet to an MBR queue.

8. A network function device, comprising:
one or more processors configured to:
provision the network function device in a core network to include a control resource device and a compute resource device;
receive data from a network session;
determine whether the data includes at least one of a first data type or a second data type; and
perform, based on the determination, at least one of a first task for the first data type using the control resource device or a second task for the second data type using the compute resource device.

9. The network function device of claim 8, wherein the one or more network function devices comprise a user plane function (UPF) device; and
wherein the first task comprises a first UPF-related task and the second task comprises a second UPF-related task.

10. The network function device of claim 9, wherein when determining whether the data includes at least one of a first data type or a second data type, the one or more processors are further configured to determine that some of the data is of an unidentified data type, and
wherein the one or more processors are further configured to select the control resource device or the compute resource device to perform a third UPF-related task for the unidentified data type.

11. The network function device of claim 8, wherein the control resource device comprises a central processing unit (CPU) provisioned on a server device; and
wherein the compute resource device comprises at least one data processing unit (DPU) provisioned on the server device.

12. The network function device of claim 11, wherein the DPU comprises a network interface card (NIC).

13. The network function device of claim 11, wherein the CPU comprises a user plane function (UPF) packet forwarding control protocol (PFCP) agent.

14. The network function device of claim 8, wherein the one or more processors are configured to:
provide priority handling for data flows having a quality of service (QoS) flow identifier (QFI) index value, corresponding to a Fifth Generation QoS identifier (5QI), wherein the providing priority handling comprises:
storing packets having a particular QFI index value in a priority queue.

15. A non-transitory, computer-readable storage media storing instructions, which, when executed by one or more processors of a network function device, cause the network function device to:
provision the network function device to include a control resource device and a compute resource device;
receive data from a network session;
determine whether the data includes at least one of a first data type or a second data type; and
perform, based on the determination, at least one of a first task for the first data type using the control resource device or a second task for the second data type using the compute resource device.

16. The non-transitory, computer-readable storage media of claim 15, wherein the one or more network function devices comprise a user plane function (UPF) device; and
wherein the first task comprises a first UPF-related task and the second task comprises a second UPF-related task.

17. The non-transitory, computer-readable storage media of claim 16, wherein when determining whether the data includes at least one of a first data type or a second data type, the one or more processors are further configured to determine that some of the data is of an unidentified data type, and
wherein the one or more processors are further configured to select the control resource device or the compute resource device to perform a third UPF-related task for the unidentified data type.

18. The non-transitory, computer-readable storage media of claim 15, wherein the control resource device comprises a central processing unit (CPU) provisioned on a server device; and
wherein the compute resource device comprises a data processing unit (DPU) provisioned on the server device.

19. The non-transitory, computer-readable storage media of claim 18, wherein the CPU comprises a user plane function (UPF) packet forwarding control protocol (PFCP) agent, and
wherein the DPU comprises a smart network interface card (SmartNIC).

20. The non-transitory, computer-readable storage media of claim 15, wherein the instructions, when executed by the one or more processors of the network function device, cause the network function device to:
provide priority handling for data flows based on a quality of service (QoS) flow identifier (QFI) index value corresponding to a Fifth Generation QoS identifier (5QI) included with received data packets.
